(19) United States
(12) Patent Application Publication
(10) Pub. No.: US 2015/0217515 A1
(43) Pub. Date: Aug. 6, 2015

(54) APPARATUS AND METHOD FOR PROCESSING MEDICAL IMAGES AND COMPUTER-READABLE RECORDING MEDIUM

(71) Applicant: SAMSUNG MEDISON CO., LTD., Gangwon-do (KR)

(72) Inventors: Myoung-kyu KIM, Gangwon-do (KR); Gil-Ju JIN, Gangwon-do (KR)

(21) Appl. No.: 14/590,930

(22) Filed: Jan. 6, 2015

(30) Foreign Application Priority Data
Feb. 4, 2014 (KR) 10-2014-0012798

(51) Int. Cl. B29C 67/00; G06T 17/00

(52) U.S. Cl. CPC B29C 67/0055; G06T 17/00; B29L 2031/7532

(57) ABSTRACT

Provided is an apparatus for processing medical images, the apparatus including: an imaging processing unit that sets an output range in a three-dimensional (3D) medical image, determines tissue properties for each region of the object that falls within the output range, and converts tissue property data representing the tissue properties of the object and the 3D medical image to a form that can be output by a 3D printer; and a communication unit that transmits the result obtained by converting the tissue property data and the 3D medical image to the 3D printer.

### RELATED APPLICATION

This application claims the benefit of Korean Patent Application No. 10-2014-0012798, filed on Feb. 4, 2014, in the Korean Intellectual Property Office, the disclosure of which is incorporated herein in its entirety by reference.

### BACKGROUND

1. Field

One or more embodiments of the present invention relate to a method and apparatus for processing medical images and a computer-readable recording medium.

2. Description of the Related Art

Ultrasound imaging systems, computed tomography (CT) systems, and magnetic resonance imaging (MRI) systems have recently provided functions of capturing three-dimensional (3D) medical images. 3D photography techniques allow users to take 3D pictures of an object and more accurately and precisely diagnose the state of the object. For example, 3D medical images may be used for ensuring the accuracy of treatment, planning a medical procedure or surgical operation, or explaining a patient's condition to the patient. However, 3D images have limitations in use for observing the state of an object, planning a medical procedure or surgical operation, etc.

### SUMMARY

One or more embodiments of the present invention include a method and apparatus for processing medical images, which allow users to more easily and precisely observe a state of an object by using three-dimensional (3D) medical images.

Additional aspects will be set forth in part in the description which follows and, in part, will be apparent from the description, or may be learned by practice of the presented embodiments.

According to one or more embodiments of the present invention, an apparatus for processing medical images includes: an imaging processing unit that sets an output range in a 3D medical image, determines tissue properties for each region of the object that falls within the output range, and converts tissue property data representing the tissue properties of the object and the 3D medical image to a form that can be output by a 3D printer; and a communication unit that transmits the result obtained by converting the tissue property data and the 3D medical image to the 3D printer.

The tissue property data may include at least one or a combination of color, density, stiffness, material, texture and elasticity designated for each region of the object.

The apparatus may further include a user interface provider that provides user interfaces for setting the output range and for designating the tissue properties,

The apparatus may further include a detection unit for measuring the tissue properties.

The image processing unit may determine an output scale of the 3D medical image.

The image processing unit may determine whether regions of the object will be output as a single unit or as separate blocks.

According to one or more embodiments of the present invention, a method of processing medical images includes: setting an output range in a 3D medical image; determining tissue properties for each region of the object that falls within the output range; converting tissue property data representing the tissue properties of the object and the 3D medical image to a form that can be output by a 3D printer; and transmitting the result obtained by converting the tissue property data and the 3D medical image to the 3D printer.

The tissue property data may include at least one or a combination of color, density, stiffness, material, texture and elasticity designated for each region of the object.

The method may further include providing a user interface for setting the output range and providing a user interface for designating the tissue properties. In the setting of the output range, the output range is set according to a user's input, and in the determining of the tissue properties for each region, the tissue properties are determined according to a user's input.

The method may further include measuring the tissue properties.

The method may further include determining an output scale of the 3D medical image.

The method may further include determining whether regions of the object will be output as a single unit or as separate blocks.

According to one or more embodiments of the present invention, a non-transitory computer-readable recording medium has recorded thereon computer program codes, which, when read and executed by a processor, performs a method of processing medical images. The method includes: setting an output range in a three-dimensional (3D) medical image; determining tissue properties for each region of the object that falls within the output range; converting tissue property data representing the tissue properties of the object and the 3D medical image to a form that can be output by a 3D printer; and transmitting the result obtained by converting the tissue property data and the 3D medical image to the 3D printer.

According to the embodiments of the present invention, users are able to easily and precisely observe a condition of the object by using 3D medical images.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates a medical image processing apparatus and a three-dimensional (3D) printer according to an exemplary embodiment of the present invention;

FIG. 2 illustrates a configuration of an apparatus for processing medical images, according to an exemplary embodiment of the present invention;

FIG. 3 illustrates a process of setting an output area, according to an exemplary embodiment of the present invention;

FIG. 4 illustrates an example of a user interface for inputting tissue property data according to an exemplary embodiment of the present invention;

FIG. 5 illustrates a process of designating tissue properties, according to an exemplary embodiment of the present invention;

FIG. 6 is a flowchart of a method of processing medical images, according to an exemplary embodiment of the present invention;

FIG. 7 illustrates a configuration of an apparatus for processing medical images, according to another exemplar embodiment of the present invention;

FIG. 8 illustrates a screen of a user interface for inputting output conditions according to an exemplary embodiment of the present invention;

FIG. 9 illustrates a model of an object according to an exemplary embodiment of the present invention;

FIG. 10 is a flowchart of a method of processing medical images, according to another exemplary embodiment of the present invention; and

FIG. 11 is a block diagram of a configuration of an ultrasound diagnostic device related to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

The terms used in this specification are those general terms currently widely used in the art in consideration of functions in regard to the present invention, but the terms may vary according to the intention of those of ordinary skill in the art, precedents, or new technology in the art. Also, specified terms may be selected by the applicant, and in this case, the detailed meaning thereof will be described in the detailed description of the invention. Thus, the terms used in the specification should be understood not as simple names but based on the meaning of the terms and the overall description of the invention.

Throughout the specification, it will also be understood that when a component “includes” an element, unless there is another opposite description thereto, it should be understood that the component does not exclude another element but may further include another element. In addition, terms such as “ . . . unit”, “ . . . module”, or the like refer to units that perform at least one function or operation, and the units may be implemented as hardware or software or as a combination of hardware and software.

Throughout the specification, an “ultrasonic image” refers to an image of an object obtained using an ultrasonic wave. Furthermore, in the present specification, an “object” may include a person or an animal, or a part of a person or an animal. For example, the object may include the liver, the heart, the womb, the brain, a breast, the abdomen, or a blood vessel. Furthermore, the “object” may include a phantom. The phantom means a material having a volume that is approximately the intensity and effective atomic number of a living organism.

Furthermore, in the present specification, a “user” refers to a medical professional, such as a doctor, a nurse, a medical laboratory technologist, a medical imaging expert, and a technician who repairs a medical apparatus, but the user is not limited thereto.

Embodiments of the invention will now be described more fully hereinafter with reference to the accompanying drawings, in which illustrative embodiments of the invention are shown.

FIG. 1 illustrates a medical image processing apparatus 100 and a three-dimensional (3D) printer 200 according to an exemplary embodiment of the present invention.

According to embodiments of the present invention, an object in a 3D medical image is output in a 3D manner by using the 3D printer 200, and a model of the object is fabricated. The medical image processing apparatus 100 converts a 3D medical image to a form in which the 3D printer 200 can output the object in a 3D manner and transmits the result of conversion to the 3D printer 200.

The 3D printer 200 is a printing device that creates a 3D model out of a 3D image. The 3D model may be built by sequential layering (e.g., additive manufacturing, rapid prototyping, etc.) or subtractive manufacturing (e.g. computer numerical control (CNC) engraving, etc.)

Additive manufacturing is a technology that creates a 3D solid object by stacking powders (e.g., plaster, nylon, etc.), liquid plastic, or plastic threads. In additive manufacturing, as each layer is thinner, a more precise solid shape may be produced. Furthermore, additive manufacturing allows coloring of the solid shape upon printing.

Subtractive manufacturing creates a 3D solid object by cutting away or engraving a mass. A subtractive manufacturing device may produce a more precise end product than an additive manufacturing device. However, the subtractive manufacturing device may consume a large amount of raw materials and require a separate coloring process. Furthermore, it may be difficult to fabricate a shape cut inward.

According to one or more embodiments of the present invention, the medical image processing apparatus 100 is configured to convert a 3D medical image to a form that can be processed by the 3D printer 200. The medical image processing apparatus 100 then transmits tissue property data along with the result obtained by converting the 3D medical image. Upon printing an object, the 3D printer 200 makes a model of the object by reflecting the tissue property data in the 3D medical image while printing the object.

The tissue property data represents tissue property for each region of the object. For example, the tissue property data may include at least one of color, density, stiffness, material, texture and elasticity designated for each region of the object, or a combination thereof. The tissue property data may match each region of the object in the 3D medical image. Properties such as the color, density, stiffness, material, and elasticity in the tissue property data may be defined as a form that can be read and output by the 3D printer 200. For example, the properties may be defined as numerical values that can be supported by the 3D printer 200.

The 3D printer 200 may create each region having different tissue properties according to tissue property data. In one embodiment, the 3D printer 200 may make tissue properties different for each region by varying the type of a material in each region. In another embodiment, the 3D printer 200 may make tissue properties different for each region by varying the density and bonding conditions of powders in the region.

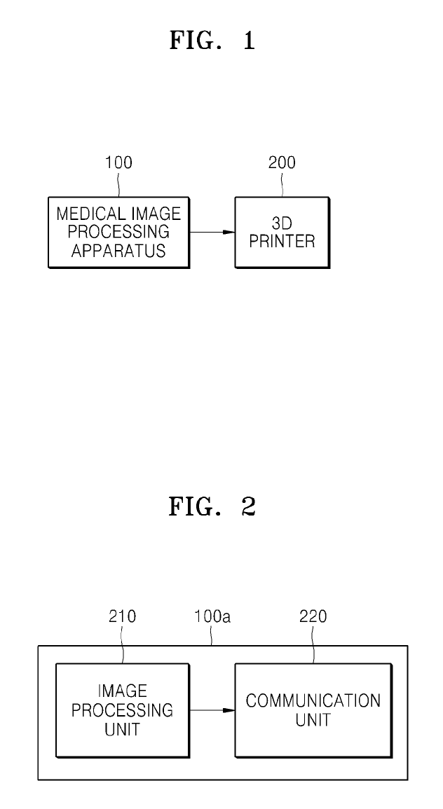

FIG. 2 illustrates a configuration of an apparatus 100a for processing medical images according to an exemplary embodiment of the present invention. The apparatus 100a includes an image processing unit 210 and a communication unit 220.

The image processing unit 210 sets an output range in a 3D medical image and outputs an object that falls within the output range. In this case, the image processing unit 210 determines tissue properties for each region of the object that falls within the output range and creates tissue property data. The image processing unit 210 converts an area in the 3D medical image that falls within the output range to a form that can be output by the 3D printer 200.

The image processing unit 210 may also generate an output command that will be output to the 3D printer 200. The output command may be generated according to a user input.

The communication unit 220 transmits the result obtained by converting the 3D medical image and the tissue property data to the 3D printer 200. Alternatively, the communication unit 220 may convert the 3D medical image and the tissue property data according to a protocol for communication with the 3D printer 200 and transmit the result to the 3D printer 200. The communication unit 220 may also transmit the output command generated by the image processing unit 210 to the 3D printer 200.

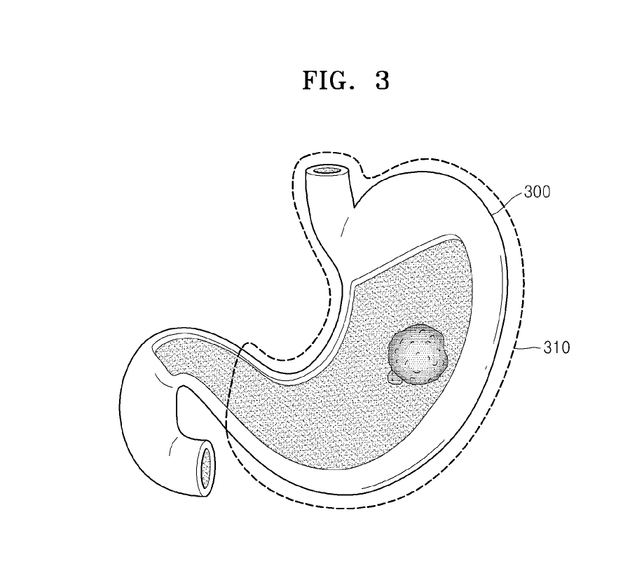

FIG. 3 illustrates a process of setting an output area, according to an exemplary embodiment of the present invention.

Referring to FIGS. 2 and 3, a user may select an output area 310 in a 3D medical image. The image processing unit 210 may provide a user interface that allows the user to select the output area 310 in the 3D medical image. For example, the image processing unit 210 may provide a user interface that displays a 3D medical image representing an object 300 and allows a user to select the output area 310 on a screen where the 3D medical image is displayed.

In one embodiment, when a user inputs a selection signal along an edge of the desired area 310, the image processing unit 210 may select the area 310 selected by the user as the output area.

In another embodiment, the image processing unit 210 provides a guide for the output area 310 that is selectable on a 3D medical image and sets the output area 310 according to a user's selection.

In another embodiment, the image processing unit 210 divides a 3D medical image into a region for which the object 300 can be output and a region for which the object 300 cannot be output and displays the regions on the 3D medical image. The image processing unit 210 may determine whether each region of the object 300 can be output based on information about the 3D printer 200. Furthermore, if the user selects a region of the object 300 that cannot be output as the output area 310, the image processing unit 210 may provide feedback indicating that the region of the object 300 cannot be output.

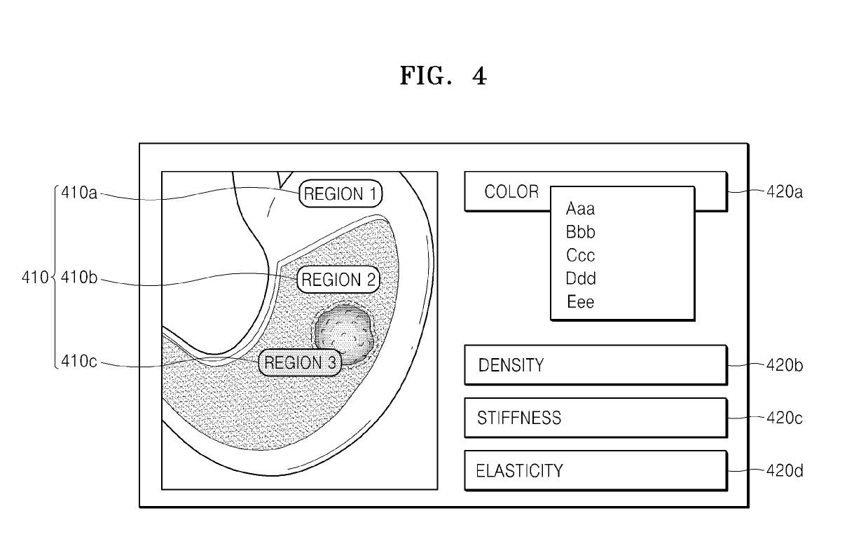

FIG. 4 illustrates an example of a user interface for inputting tissue property data according to an exemplary embodiment of the present invention.

Referring to FIGS. 2 and 4, according to an embodiment of the present invention, the tissue property data may be set according to a user's input. The image processing unit 210 may provide a user interface that allows a user to select tissue property data.

As shown in FIG. 4, a user interface for selecting tissue property data (hereinafter referred to as a ‘tissue property designation UI’) displays a region of the object 300 selected as the output area 310 on a user interface screen. Furthermore, the tissue property designation UI partitions a portion of the object 300 corresponding to the output area 310 into multiple regions for display. In the present embodiment, the partitioned portion of the object 300 may include a plurality of regions REGION 1 through REGION 3 that have tissue properties that are differently designated.

The tissue property designation UI is displayed so that the user may select the plurality of regions REGION 1 through REGION 3 in the object 300. As the user selects each of the plurality of regions REGION 1 through REGION 3, the user may designate tissue property of the region REGION 1, REGION 2, or REGION 3. The tissue property designation UI may display icons 410a through 410c for selecting the plurality of regions REGION 1 through REGION 3, respectively, along with a 3D medical image of the object 300. The user may select a region that has a tissue property that is designated by selecting the icons 410a through 410c.

The image processing unit 210 may partition the output area 310 of the object 300 into a plurality of regions based on at least one or a combination of image characteristics and measurement results.

In one embodiment, the image processing unit 210 may define a plurality of regions based on a boundary of a brightness values distributed in the output area 310. For example, the image processing unit 210 may determine a line consisting of points where brightness values of the 3D medical image change and define the plurality of regions along the line.

In another embodiment, the image processing unit 210 may define a plurality of regions by using information about a pattern of the object 300 contained in the output area 310 of the object 300. For example, if the object 300 is a stomach, portions of the stomach may be defined as the plurality of regions, respectively. Each portion of the stomach may be detected by using a method such as pattern matching.

In another embodiment, the image processing unit 210 may define a plurality of regions based on the results of measurement of the object 300. For example, the apparatus 100a for processing medical images may define portions of the object 300 that have similar physical properties based on data about physical properties of the object 300. The physical properties of the object 300 may include stiffness and elasticity thereof.

A tissue property designation UI according to an embodiment of the present invention may include a color designation menu 420a, a density designation menu 420b, a stiffness designation menu 420c, and an elasticity designation menu 420d (hereinafter, collectively called “menus”). The user may designate tissue properties of each region by using the menus 420a through 420d. Furthermore, the types of the menus 420a through 420d may be determined in various ways depending on the application.

In one embodiment, some tissue properties may be set automatically while the remaining tissue properties may be set by a user. For example, a color or stiffness of an object may be automatically set based on a measurement value while a density or elasticity thereof may be set according to a user's input.

In another embodiment, each of the menus 420a through 420d may indicate recommended values. For example, the image processing unit 110 may provide recommended values for color, density, and stiffness based on information on what tissue (e.g., the stomach lining) matches each region of the object. The recommended values correspond to general tissue properties of each tissue and may be stored in advance for later use.

In another embodiment, if tissue properties to be input are not designated by a user, the tissue properties may be set to default values. This configuration may allow creation of a 3D model for a region of interest (ROI) in an object even if the user does not input all tissue properties.

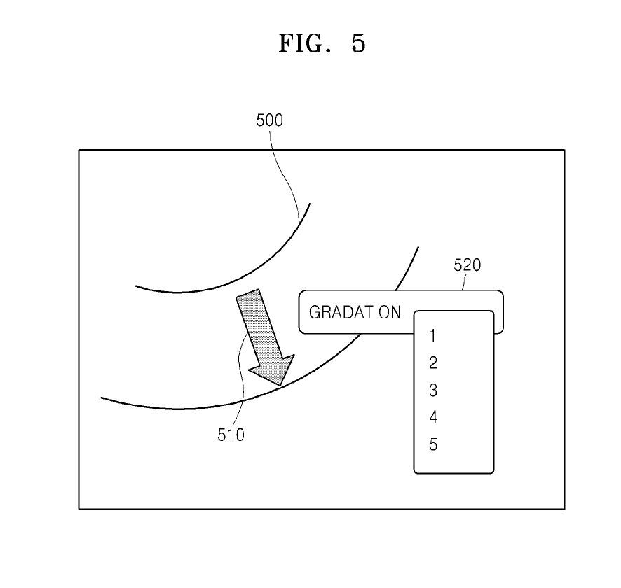

FIG. 5 illustrates a process of designating tissue properties, according to an exemplary embodiment of the present invention.

According to the present embodiment, it is possible to designate a gradual change in tissue properties of a portion of the object in a tissue property designation UI. For example, as shown in FIG. 5, it may be possible to designate a region 500 where tissue properties gradually change and a direction 510 in which the tissue properties change and provide a menu 520 for designating a gradient of a change in the tissue properties. The user may designate how sharply the tissue properties change by designating a gradient of the change in the tissue properties. Furthermore, for a region where the tissue properties change, the user may designate maximum and minimum values of the tissue properties of the region.

In another embodiment, the user may designate a change in tissue properties by designating tissue properties for each point.

In another embodiment, the user may designate a change in tissue properties in the shape of a contour line.

In response to an output command, the 3D printer 200 outputs an object, which appears in the 3D medical image, in a 3D manner, thereby creating a model of an output area of the object. According to embodiments of the present invention, a model of the object may be created by reflecting tissue properties designated for each region. For example, a model of the stomach may be built so that regions such as the stomach lining, the stomach outer wall, a cardiac part, a cardiac notch, a pyloric part, etc. have different tissue properties (e.g., color, density, stiffness, elasticity, etc.) according to tissue property data designated for the regions.

Furthermore, according to the embodiments of the present invention, it is possible to make a model of an object including a lesion. The user may produce an object including a lesion and use it for a more detailed diagnosis, the simulation and study of a medical procedure or surgery, or explaining to patients their conditions.

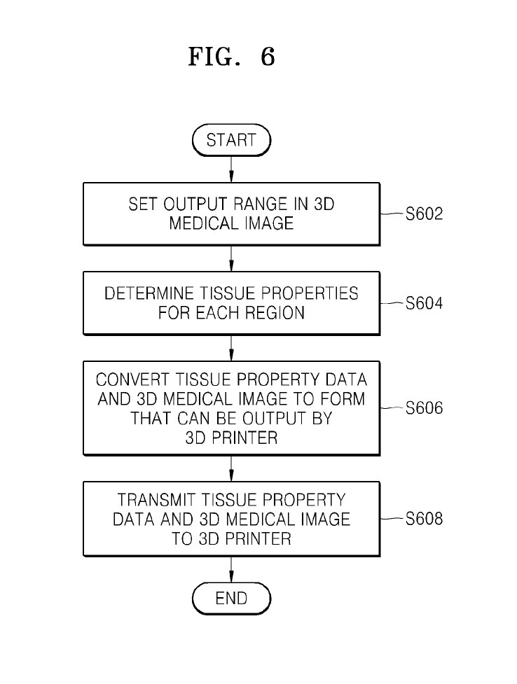

FIG. 6 is a flowchart of a method of processing medical images, according to an exemplary embodiment of the present invention.

According to the method of processing medical images according to the present embodiment, an output range is set in a 3D medical image (S602). The output range in the 3D medical image may be determined according to a user's input.

Next, tissue properties may be determined for each region within an output range (S604). Each region of the object may be designated automatically by a medical image processing apparatus or according to a user's input. The tissue properties of each region may also be designated automatically or according to a user's input.

Tissue property data and an area in the 3D medical image corresponding to the output range are converted to a form that can be output by a 3D printer (S606). For example, the area in the 3D medical image and the tissue property data may be converted according to a protocol used in the 3D printer. The tissue property data may include tissue property data corresponding to each region of the 3D medical image.

The result obtained by converting the 3D medical image and the tissue property data is thereafter transmitted to the 3D printer (S608). In this case, an output command may also be transmitted together with the result to the 3D printer.

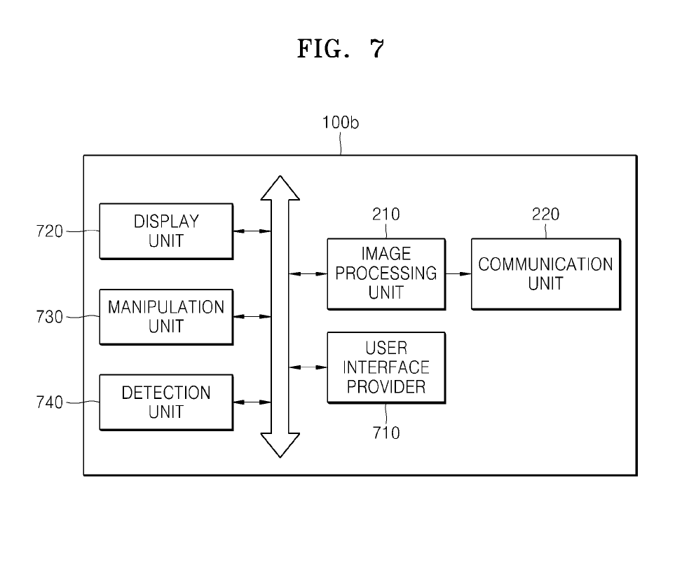

FIG. 7 illustrates a configuration of an apparatus 100b for processing medical images, according to another exemplar embodiment of the present invention. Referring to FIG. 7, the apparatus 100b according to the present embodiment may include an image processing unit 210, a communication unit 220, a user interface provider 710, a display unit 720, a manipulation unit 730, and a detection unit 740.

The image processing unit 210 sets an output range in a 3D medical image, determines tissue properties of the object within the output range for each region of the object, and generates tissue property data. The image processing unit 210 also converts the tissue property data and an area in the 3D medical image corresponding to the output range into a form that can be output by the 3D printer 200 (see FIG. 1).

The image processing unit 210 may generate an output command and transmit the output command to the 3D printer 200. For example, the output command may be generated according to a user's input.

The communication unit 220 transmits the result obtained by converting the 3D medical image and the tissue property data to the 3D printer 200. The communication unit 220 may convert the 3D medical image and the tissue property data according to a protocol for communication with the 3D printer 200 and transmit the result to the 3D printer 200. The communication unit 220 may also transmit the output command generated by the image processing unit 210 to the 3D printer 200.

The user interface provider 710 may provide user interfaces for setting an output area and for setting tissue properties. A user interface screen may be provided as described above with reference to FIGS. 3 through 5. The user interface may also be provided by using the display unit 720 and the manipulation unit 730.

The display unit 720 may be a liquid crystal display (LCD) or an organic light-emitting diode (OLED) display that displays the 3D medical image, the user interface screen, etc.

The manipulation unit 730 is a component that allows a user to input a control signal. The manipulation unit 730 may be formed as a keypad, a track ball, a jog dial, a touch pad, a touch screen, or a mouse.

The detection unit 740 measures tissue properties of the object. For example, the detection unit 740 may measure tissue properties (e.g., stiffness, etc.) by using an ultrasound signal.

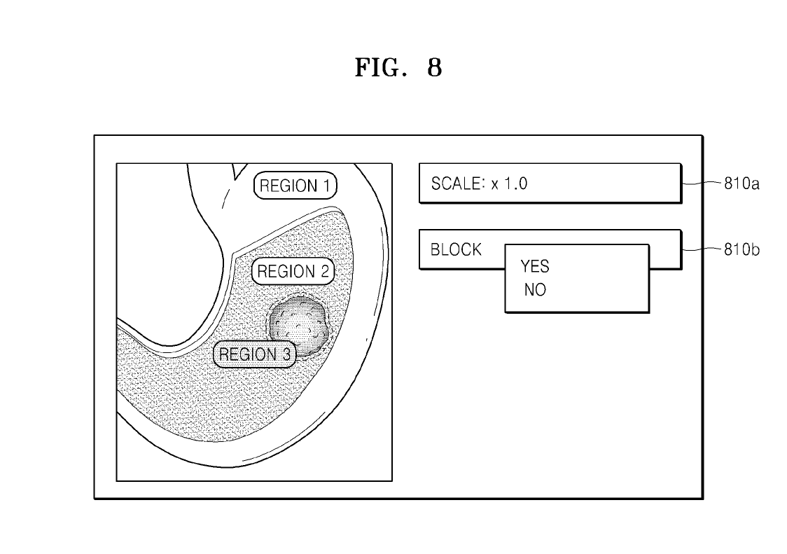

FIG. 8 illustrates a screen of a user interface for setting output conditions (hereinafter, referred to as an “output condition setting UI”), according to an exemplary embodiment of the present invention.

According to the present embodiment, the image processing unit 210 may determine an output scale according to a user's input through a user interface. For example, the output scale may be designated as x1.0, x1.5, and x2.0. The “output condition setting UI may include an output scale designation menu 810a.

Furthermore, when outputting an object, the image processing unit 210 may determine whether a plurality of regions of the object will be output as a single unit or as separate blocks. If the object is output in separate blocks, all or some regions of the object may be output as separate blocks. For example, the user may set, for each region, whether the region is to be output as a separate block, by using a block designation menu 810b. The image processing unit 210 may provide information about whether each region will be output as a separate block through a user interface screen. If the region cannot be output as a separate block, the user interface provider 710 may deactivate the block designation menu 810b.

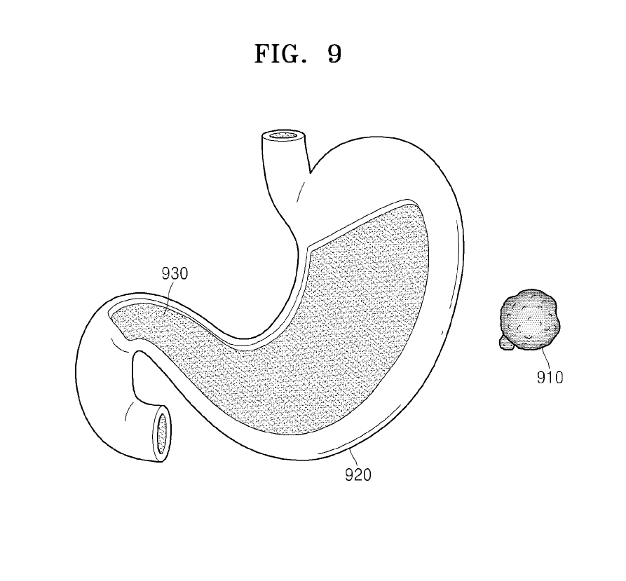

FIG. 9 illustrates a model of an object according to an exemplary embodiment of the present invention.

In one embodiment, as shown in FIG. 9, the model of the object may be manufactured in a 3D manner. The model of the object includes a plurality of regions, each region having tissue properties designated for the region. For example, a stomach lining 930 and a stomach outer wall 920 may be output so that they have different tissue properties.

Furthermore, some regions of the object may be output as separate blocks. For example, the user may designate a lesion 910 as being output as a separate block.

The user may observe regions of the object more precisely by designating some or all of the regions of the object as being output as separate blocks.

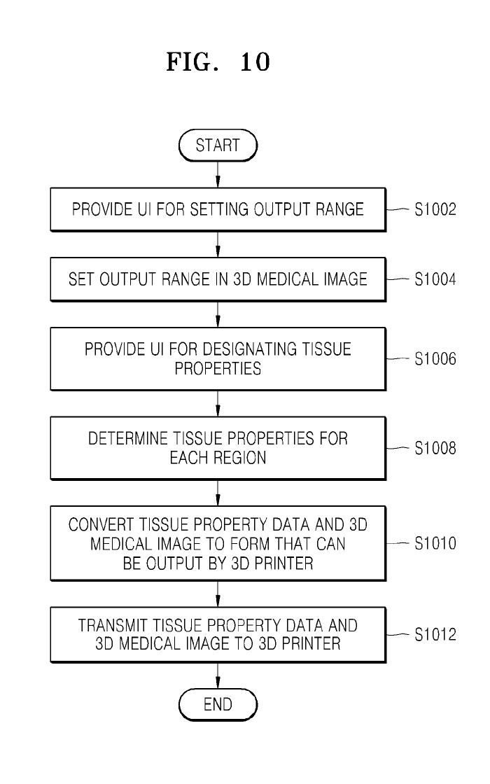

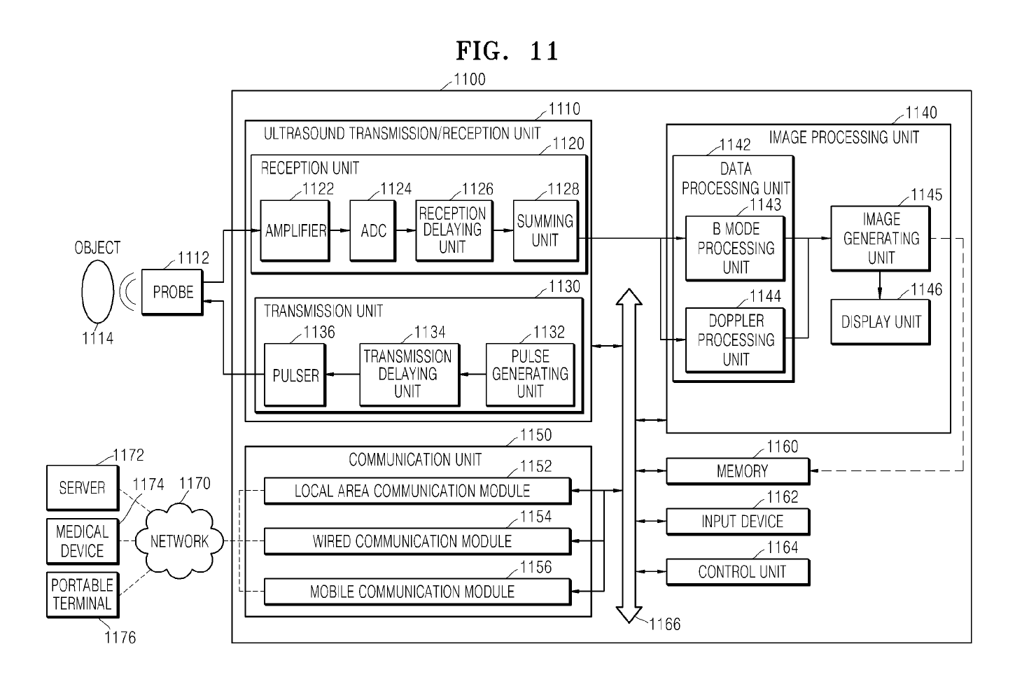

FIG. 10 is a flowchart of a method of processing medical images, according to another exemplary embodiment of the present invention.

In the method of processing medical images according to the present embodiment, first, a user interface for setting an output range is provided (S1002). For example, the user interface may be provided as shown in FIG. 3.

Next, the output range is set in a 3D medical image according to a user's input (S1004).

Then, a tissue property designation UI for designating tissue properties is provided (S1006), and the tissue properties are determined for each region according to a user's input (S1008). Furthermore, tissue property data is created according to the user's input.

After the tissue property data is created, an area in the 3D medical image corresponding to the output range and the tissue property data are converted into a form that can be output by the 3D printer 200 (see FIG. 1) (S1010).

Thereafter, the tissue property data and the area in the 3D medical image corresponding to the output range are transmitted to the 3D printer 200 (S1012).

FIG. 11 is a block diagram of a configuration of an ultrasound diagnostic device 1100 according to an embodiment of the present invention. The medical image processing apparatuses 100, 100a, and 100b according to the embodiments of the present invention may be realized as the ultrasound diagnostic device 1100.

The ultrasound diagnostic device 1100 according to the present embodiment may include a probe 1112, an ultrasound transmission/reception unit 1110, an image processing unit 1140, a communication unit 1150, a memory 1160, an input device 1162, and a control unit 1164, and the components may be connected to one another via buses 1166.

The ultrasound diagnostic device 1100 may be embodied not only as a cart type device but also as a portable type. Examples of portable ultrasound diagnostic devices may include a PACS viewer, a smartphone, a laptop computer, a personal digital assistant (PDA), and a tablet PC. However, the present invention is not limited thereto.

The probe 1112 transmits ultrasound signals to an object 1114 based on a driving signal applied by the ultrasound transmission/reception unit 1110 and receives echo signals reflected from the object 1114. The probe 1112 includes a plurality of transducers, and the plurality of transducers oscillate based on electric signals transmitted thereto and generate acoustic energy, that is, ultrasound waves. Furthermore, the probe 1112 may be connected to a main body of the ultrasound diagnostic device 1100 wiredly or wirelessly. According to embodiments of the present invention, the ultrasound diagnostic device 1100 may include a plurality of probes 1112.

A transmission unit 1130 supplies a driving signal to the probe 1112 and includes a pulse generating unit 1132, a transmission delaying unit 1134, and a pulser 1136. The pulse generating unit 1132 generates pulses for forming transmission ultrasound waves based on a predetermined pulse repetition frequency (PRF), and the transmission delaying unit 1134 applies a delay time for determining transmission directionality to the pulses. Pulses, to which a delay time is applied, correspond to a plurality of piezoelectric vibrators included in the probe 1112, respectively. The pulser 1136 applies a driving signal (or a driving pulse) to the probe 1112 at a timing corresponding to each pulse to which a delay time is applied.

A reception unit 1120 generates ultrasound data by processing echo signals received from the probe 1112. The reception unit 1120 may include an amplifier 1122, an analog-to-digital converter (ADC) 1124, a reception delaying unit 1126, and a summing unit 1128. The amplifier 1122 amplifies echo signals in each channel, and the ADC 1124 performs analog-to-digital conversion on the amplified echo signals. The reception delaying unit 1126 applies delay times for determining reception directionality to the echo signals subjected to the analog-to-digital conversion, and the summing unit 1128 generates ultrasound data by summing the echo signals processed by the reception delaying unit 1126. According to embodiments of the present invention, the reception unit 1120 may not include the amplifier 1122. In other words, if the sensitivity of the probe 1112 or the capability of the ADC 1124 to process bits is enhanced, the amplifier 1122 may be omitted.

The image processing unit 1140 generates an ultrasound image by scan-converting ultrasound data generated by the ultrasound transmission/reception unit 1110 and displays the ultrasound image. In addition, an ultrasound image may include not only a gray-scale ultrasound image obtained by scanning an object in an amplitude (A) mode, a brightness (B) mode, and a motion (M) mode, but also a Doppler image representing a moving object by using a Doppler effect. The Doppler image may include a blood flow Doppler image (also called a color Doppler image) showing a flow of blood, a tissue Doppler image showing movement of tissue, and a spectral Doppler image showing a moving speed of an object as a waveform.

A B mode processing unit 1143 extracts B mode components from ultrasound data and processes the B mode components. An image generating unit 1145 may generate an ultrasound image indicating signal intensities as brightness based on the extracted B mode components.

Similarly, a Doppler processing unit 1144 may extract Doppler components from ultrasound data, and the image generating unit 1145 may generate a Doppler image indicating movement of an object as colors or waveforms based on the extracted Doppler components.

The image generating unit 1145 according to an embodiment of the present invention may generate a 3D ultrasound image via volume-rendering of volume data and an elasticity image which visualizes the degree of deformation of the object 1114 due to pressure. Furthermore, the image generating unit 1145 may display various additional information in an ultrasound image by using text and graphics. In addition, the generated ultrasound image may be stored in the memory 1160.

A display unit 1146 displays and outputs the generated ultrasound image. The display unit 1146 may display and output not only an ultrasound image but also various information processed by the ultrasound diagnostic device 1100 on a screen via a graphical user interface (GUI). In addition, the ultrasound diagnostic device 1100 may include two or more display units 1146 according to embodiments of the present invention.

The communication unit 1150 is wiredly or wirelessly connected to a network 1170 and communicates with an external device or a server. The communication unit 1150 may exchange data with a hospital server or another medical device in a hospital that is connected via a picture archiving and communications system (PACS). Furthermore, the communication unit 1150 may perform data communication according to the digital imaging and communications in medicine (DICOM) standard.

The communication unit 1150 may transmit or receive data related to diagnosis of the object 1114, e.g., an ultrasound image, ultrasound data, and Doppler data of the object 1114, via the network 1170. The communication unit 1150 may also transmit or receive medical images obtained by other medical devices, such as a CT image, a MR image, and an X-ray image. Furthermore, the communication unit 1150 may receive information related to a diagnosis history or a treatment schedule of a patient from a server and utilizes the information for diagnosing the patient. Furthermore, the communication unit 1150 may perform data communication with a server or a medical device in a hospital as well as a portable terminal of a doctor or a patient.

The communication unit 1150 is connected to the network 1170 in a wired or wireless manner and may exchange data with a server 1172, a medical device 1174, or a portable terminal 1176. The communication unit 1150 may include at least one component that enables communication with external devices, e.g., a local area communication module 1152, a wired communication module 1154, and a mobile communication module 1156.

The local area communication module 1152 is a module for performing local area communication with a device within a predetermined distance. Examples of local area communication technology include a wireless local area network (LAN), Wi-Fi, Bluetooth, ZigBee, Wi-Fi direct (WFD), ultra wideband (UWB), infrared data association (IrDA), Bluetooth low energy (BLE), and near field communication (NFC), but are not limited thereto.

The wired communication module 1154 is a module for performing communication by using an electric signal or an optical signal. Examples of wired communication technology include wired communication technologies using a pair cable, a coaxial cable, and an optical fiber cable, and an Ethernet cable.

The mobile communication module 1156 transmits or receives wireless signals to or from at least one of a base station, an external terminal, and a server on a mobile communication network. Here, the wireless signals may include voice call signals, video call signals, or various types of data for transmission and reception of text/multimedia messages.

The memory 1160 stores various data processed by the ultrasound diagnostic device 1100. For example, the memory 1160 may store not only medical data related to the diagnosis of the object 1114, such as ultrasound data and ultrasound image that are input or output, but also algorithms or programs that are executed in the ultrasound diagnostic device 1100.

The memory 1160 may be embodied as any of various storage media such as a flash memory, a hard disk drive, and an Electrically Erasable Programmable Read-Only Memory (EEPROM). Furthermore, the ultrasound diagnostic device 1100 may utilize a web storage or a cloud server that functions as the memory 1160 online.

The input device 1162 is a means via which a user inputs data for controlling the ultrasound diagnostic device 1100. The input device 1162 may include hardware components, such as a keypad, a mouse, a touch panel, a touch screen, and a jog switch. However, the present invention is not limited thereto, and the input device 1162 may further include various other input elements such as an electrocardiogram measuring module, a respiration measuring module, a voice recognition sensor, a gesture recognition sensor, a fingerprint recognition sensor, an iris recognition sensor, a depth sensor, a distance sensor, etc.

The control unit 1164 may control overall operations of the ultrasound diagnostic device 1100. In other words, the control unit 1164 may control operations among the probe 1112, the ultrasound transmission/reception unit 1110, the image processing unit 1140, the communication unit 1150, the memory 1160, and the input device 1162.

All or some of the probe 1112, the ultrasound transmission/reception unit 1110, the image processing unit 1140, the communication unit 1150, the memory 1160, the input device 1162, and the control unit 1164 may be operated by software modules. However, the present invention is not limited thereto, and some of the above components may be operated by hardware modules. Furthermore, at least one of the ultrasound transmission/reception unit 1110, the image processing unit 1140, and the communication unit 1150 may be included in the control unit 1164, but are not limited thereto.

The image processing unit 210 shown in FIG. 2 may correspond to the image processing unit 1140 shown in FIG. 11.

The communication unit 220 shown in FIG. 2 may correspond to the communication unit 1150 shown in FIG. 11.

Furthermore, the user interface provider 710 shown in FIG. 7 may correspond to the control unit 1164 and the image processing unit 1140 shown in FIG. 11.

The display unit 720 and the manipulation unit 730 shown in FIG. 7 may correspond to the display unit 1146 and the input device 1162 shown in FIG. 11, respectively. The detection unit 740 shown in FIG. 7 may correspond to the probe 1112, the ultrasound transmission/reception unit 1110, and the image processing unit 1140 shown in FIG. 11.

According to another embodiment of the present invention, the medical image processing apparatuses 100, 100a, and 100b may be realized as computed tomography (CT) or magnetic resonance imaging (MRI) diagnostic equipment.

A method of processing medical images according to an embodiment of the present invention may be Implemented as a software module or algorithm. Methods implemented as software modules or algorithms may be stored on a computer-readable storage medium as computer-readable codes or program instructions that can be executed on a processor. Examples of computer-readable storage media include magnetic storage media (e.g., ROM, RAM, floppy disks, hard disks, etc.) and optical recording media (e.g., CD-ROMs, DVDs, etc.). The computer-readable storage media can also be distributed over a network-coupled computer systems so that computer-readable codes are stored and executed in a distributed fashion. the computer-readable codes may be read by a computer, stored in a memory, and executed on a processor. When the storage media are connected to the medical image processing apparatus 100, the medical image processing apparatus 100 may be configured to perform methods of processing medical images, according to embodiments of the present invention.

While one or more embodiments of the present invention have been described with reference to the figures, it will be understood by those of ordinary skill in the art that various changes in form and details may be made therein without departing from the spirit and scope of the present invention as defined by the following claims. Thus, it should be understood that the exemplary embodiments described therein should be considered in a descriptive sense only and not for purposes of limitation.

What is claimed is:

1. An apparatus for processing medical images, the apparatus comprising:
an imaging processing unit that sets an output range in a three-dimensional (3D) medical image, determines tissue properties for each region of the object that falls within the output range, and converts tissue property data representing the tissue properties of the object and the 3D medical image to a form that can be output by a 3D printer; and
a communication unit that transmits the result obtained by converting the tissue property data and the 3D medical image to the 3D printer.

2. The apparatus of claim 1, wherein the tissue property data includes at least one or a combination of color, density, stiffness, material, texture and elasticity designated for each region of the object.

3. The apparatus of claim 1, further comprising a user interface provider that provides user interfaces for setting the output range and for designating the tissue properties,
wherein the image processing unit sets the output range and determines the tissue properties according to a user's input.

4. The apparatus of claim 1, further comprising a detection unit for measuring the tissue properties.

5. The apparatus of claim 1, wherein the image processing unit determines an output scale of the 3D medical image.

6. The apparatus of claim 1, wherein the image processing unit determines whether regions of the object will be output as a single unit or as separate blocks.

7. A method of processing medical images, the method comprising:
setting an output range in a three-dimensional (3D) medical image;
determining tissue properties for each region of the object that falls within the output range;
converting tissue property data representing the tissue properties of the object and the 3D medical image to a form that can be output by a 3D printer; and
transmitting the result obtained by converting the tissue property data and the 3D medical image to the 3D printer.

8. The method of claim 7, wherein the tissue property data includes at least one or a combination of color, density, stiffness, material, texture and elasticity designated for each region of the object.

9. The method of claim 7, further comprising:
providing a user interface for setting the output range; and
providing a user interface for designating the tissue properties,
wherein in the setting of the output range, the output range is set according to a user's input, and
wherein in the determining of the tissue properties for each region, the tissue properties are determined according to a user's input.

10. The method of claim 7, further comprising measuring the tissue properties.

11. The method of claim 7, further comprising determining an output scale of the 3D medical image.

12. The method of claim 7, further comprising determining whether regions of the object will be output as a single unit or as separate blocks.

13. A non-transitory computer-readable recording medium having recorded thereon computer program codes, which, when read and executed by a processor, performs a method of processing medical images, the method comprising:
setting an output range in a three-dimensional (3D) medical image;
determining tissue properties for each region of the object that falls within the output range;
converting tissue property data representing the tissue properties of the object and the 3D medical image to a form that can be output by a 3D printer; and
transmitting the result obtained by converting the tissue property data and the 3D medical image to the 3D printer.

14. The medium of claim 13, wherein the tissue property data includes at least one or a combination of color, density, stiffness, material, texture and elasticity designated for each region of the object.

15. The medium of claim 13, wherein the method further comprises:
providing a user interface for setting the output range; and
providing a user interface for designating the tissue properties,
wherein in the setting of the output range, the output range is set according to a user's input, and
wherein in the determining of the tissue properties for each region, the tissue properties are determined according to a user's input.

16. The medium of claim 13, wherein the method further comprises measuring the tissue properties.

17. The medium of claim 13, wherein the method further comprises determining an output scale of the 3D medical image.

18. The medium of claim 13, wherein the method further comprises determining whether regions of the object will be output as a single unit or as separate blocks.
